(19) United States
(12) Patent Application Publication
(10) Pub. No.: US 2023/0325462 A1
(43) Pub. Date: Oct. 12, 2023

(54) APPARATUS AND METHOD WITH ACCELERATING ARTIFICIAL NEURAL NETWORK

(71) Applicant: SAMSUNG ELECTRONICS CO., LTD., Suwon-si (KR)

(72) Inventors: Gopinath Vasanth MAHALE, Ankola (IN); Pramod Parameshwara UDUPA, Bengaluru (IN); Jun-Woo JANG, Suwon-si (KR); Kiran Kolar CHANDRASEKHARAN, Bengaluru (IN); Sehwan LEE, Suwon-si (KR)

(73) Assignee: SAMSUNG ELECTRONICS CO., LTD., Suwon-si (KR)

(21) Appl. No.: 18/296,165

(22) Filed: Apr. 5, 2023

(30) Foreign Application Priority Data
Apr. 6, 2022 (IN) 202241020732
Mar. 2, 2023 (KR) 10-2023-0027983

(51) Int. Cl. G06F 17/14; G06N 3/0464; G06F 7/544

(52) U.S. Cl. CPC G06F 17/14; G06N 3/0464; G06F 7/5443

(57) ABSTRACT

A processor-implemented apparatus includes a forward transform module configured to transform input feature maps (IFMs) by performing a forward transform operation in a Winograd convolution (WinConv) domain, multiply and accumulate array (MAA) units configured to multiply the transformed IFMs by transformed kernels and perform a first inverse transform operation based on results of the multiplying, and an inverse transform module configured to generate output feature maps (OFMs) based on a result of the first inverse transform operation.

### CROSS-REFERENCE TO RELATED APPLICATIONS

This application claims the benefit under 35 USC § 119(a) of Indian Patent Application No. 202241020732 filed on Apr. 6, 2022, in the Indian Patent Office, and Korean Patent Application No. 10-2023-0027983 filed on Mar. 2, 2023, in the Korean Intellectual Property Office, the entire disclosures of which are incorporated herein by reference for all purposes.

### BACKGROUND

### 1. Field

The following description relates to a method and apparatus with accelerating an artificial neural network.

### 2. Description of Related Art

Many advanced applications, such as image processing, machine translation, object detection, autonomous vehicles, real-time face recognition, and the like, are now processed using artificial intelligence (AI) algorithms or machine learning (ML) algorithms. A neural processing unit (NPU) is a microprocessor designed specifically for the acceleration of AI/ML algorithms, typically by operating on predictive models, such as convolutional neural networks (CNNs), deep convolutional networks (DCNs), artificial neural networks (ANNs), and the like. The NPU may be part of a large system-on-chip (SoC) or part of a dedicated neural-network accelerator. The NPU enables processing of data using AI/ML algorithms on devices itself without being dependent on a cloud server.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented apparatus includes a forward transform module configured to transform input feature maps (IFMs) by performing a forward transform operation in a WinConv domain, multiply and accumulate array (MAA) units configured to multiply the transformed IFMs by transformed kernels and perform a first inverse transform operation based on results of the multiplying, the MAA units including adder trees and multipliers, and an inverse transform module configured to generate output feature maps (OFMs) based on a result of the first inverse transform operation.

The MAA units may be configured to perform the first inverse transform operation based on the results of the multiplying and an output transformation matrix that is transposed. The inverse transform module may be configured to generate the OFMs by performing a second inverse transform operation on the result of the first inverse transform operation and the output transformation matrix.

The MAA units may include a first set of MAA units and a second set of MAA units. The first set of MAA units may correspond to first alternate MAA units, and the second set of MAA units may correspond to second alternate MAA units.

The first set of MAA units may include a first set of multipliers among the multipliers. The second set of MAA units may include a second set of multipliers other than the first set of multipliers among the multipliers. The second set of MAA units may be configured to disable the second set of multipliers based on a zero gating at input terminals of the second set of multipliers, during the multiplying of the transformed IFMs and the transformed kernels in the first set of MAA units.

A first number of multipliers in the first set of multipliers may be used by the first set of MAA units for the multiplying of the transformed IFMs and the transformed kernels. A second number of multipliers other than the first number of multipliers in the first set of multipliers may be disabled during the multiplying of the transformed IFMs and the transformed kernels based on a zero gating at input terminals of the second number of multipliers.

The MAA units may be configured to perform the first inverse transform operation based on the results of the multiplying, using an addition operation in the adder trees, and generate a plurality of dot products as the result of the first inverse transform operation.

The inverse transform module may be configured to perform a second inverse transform operation on the result of the first inverse transform operation, using a WinConv inverse transform operation, and generate the OFMs based on a result of the second inverse transform operation.

The transformed kernels may be transformed into the WinConv domain by the plurality of MAA units.

The apparatus may further include a plurality of memory banks configured to store channels of coordinates of each of the IFMs as IFM blocks in a z-first data storage layout and transmit the IFM blocks to an IFM fetcher, and the IFM fetcher configured to fetch the IFM blocks.

The apparatus may further include a data staging unit configured to distribute the transformed IFMs into a plurality of IFM buffers and rearrange the transformed IFMs so that four pixels per channel are provided together at an input terminal of each of the plurality of MAA units.

The forward transform module may be configured to select a transformation matrix and a transposed transformation matrix based on a size of a kernel and a position of an IFM window, and transform the IFMs into the WinConv domain based on the size of the kernel, the selected transformation matrix, and the selected transposed transformation matrix, to generate the transformed IFMs.

In another general aspect, a processor-implemented method includes transforming IFMs based on a forward transform operation in a WinConv domain, multiplying, by MAA units, the transformed IFMs by transformed kernels, the MAA units including adder trees and multipliers, performing a first inverse transform operation based on results of the multiplying, and generating OFMs based on a result of the first inverse transform operation.

The performing of the first inverse transform operation may include performing the first inverse transform operation based on the results of the multiplying and an output transformation matrix that is transposed. The generating of the OFMs may include generating the OFMs by performing a second inverse transform operation on the result of the first inverse transform operation and the output transformation matrix.

The plurality of MAA units may include a first set of MAA units and a second set of MAA units. The first set of MAA units may correspond to first alternate MAA units, and the second set of MAA units may correspond to second alternate MAA units.

The first set of MAA units may include a first set of multipliers among the multipliers. The second set of MAA units may include a second set of multipliers other than the first set of multipliers among the multipliers. The second set of MAA units may be configured to disable the second set of multipliers based on a zero gating at input terminals of the second set of multipliers, during the multiplying of the transformed IFMs and the transformed kernels in the first set of MAA units.

A first number of multipliers in the first set of multipliers may be used by the first set of MAA units for the multiplying of the transformed IFMs and the transformed kernels. A second number of multipliers other than the first number of multipliers in the first set of multipliers may be disabled during the multiplying of the transformed IFMs and the transformed kernels based on a zero gating at input terminals of the second number of multipliers.

The MAA units may be configured to perform the first inverse transform operation based on the results of the multiplying, using an addition operation in the adder trees, and generate a plurality of dot products as the result of the first inverse transform operation.

The generating of the OFMs may include performing a second inverse transform operation on the result of the first inverse transform operation, using a WinConv inverse transform operation, and generating the OFMs based on a result of the second inverse transform operation.

The transformed kernels may be transformed into the WinConv domain by the MAA units.

The method may further include storing channels of coordinates of each of the IFMs as IFM blocks in a z-first data storage layout, and fetching the IFM blocks.

Other features and aspects will be apparent from the following detailed description, the drawings, and the claims.

### BRIEF DESCRIPTION OF THE DRAWINGS

FIG. 1 illustrates an example of a two-dimensional (2D) Winograd convolution (WinConv) method.

FIG. 2 illustrates an example of transformation matrices used in a WinConv method.

FIG. 3 illustrates an example of a baseline architecture for a three-dimensional (3D) convolution.

FIG. 4 illustrates an example 3D WinConv mapping of a baseline architecture.

FIG. 5 illustrates a method of mapping a depth-wise convolution on a baseline architecture.

FIGS. 6A and 6B illustrate an example method of performing a WinConv operation according to one or more embodiments.

FIG. 7 illustrates an example system for performing a WinConv operation according to one or more embodiments.

FIG. 8 illustrates an example distribution of forward-transformed input feature maps (IFMs) inputted into data buffers according to one or more embodiments.

FIG. 9 illustrates an example computation performed by XMAAs (groups of Multiply and Accumulate Arrays (MAAs)) in a depth-wise WinConv mode according to one or more embodiments.

FIG. 10 illustrates an example computation performed by XMAAGs (groups of XMAAs) in a depth-wise WinConv mode according to one or more embodiments.

FIG. 11 illustrates an example comparison of results of a depth-wise convolution operation according to one or more embodiments.

FIG. 12 illustrates an example of a comparison of energy spent in a depth-wise convolution according to one or more embodiments.

Throughout the drawings and the detailed description, unless otherwise described or provided, the same or like drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C’, and the like are intended to have disjunctive meanings, and these phrases “at least one of A, B, and C”, “at least one of A, B, or C’, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

The examples may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, the examples will be described in detail with reference to the accompanying drawings. When describing the examples with reference to the accompanying drawings, like reference numerals refer to like components and a repeated description related thereto will be omitted.

As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card

Machine learning tasks, such as image classification and image segmentation, are typically implemented using CCNs. Matrix multiplication operations and convolution operations form an integral part of the present day CNNs and involve billions of such operations for image processing. For a CNN targeting energy-constrained devices, light-weight depth-wise separable layers may be used, which generally have two types of computations, namely, a point-wise three-dimensional (3D) convolution with 1×1 kernels and a depth-wise two-dimensional (2D) convolution with the same number of input and output feature maps. The CNNs require large amounts of computing resources because of computationally intensive convolution layers. One method of reducing the computational complexity of convolutions without losing the accuracy is to use a Winograd-based covolution (WinConv). A typical WinConv method reduces the number of multiplications and increasing the number of additions and subtractions. For instance, for 3×3 convolutions, the number of multiplications is reduced by approx. 2.25 times. Moreover, the reduction is 1.5 times in the case of 3×1 and 1×3 convolutions.

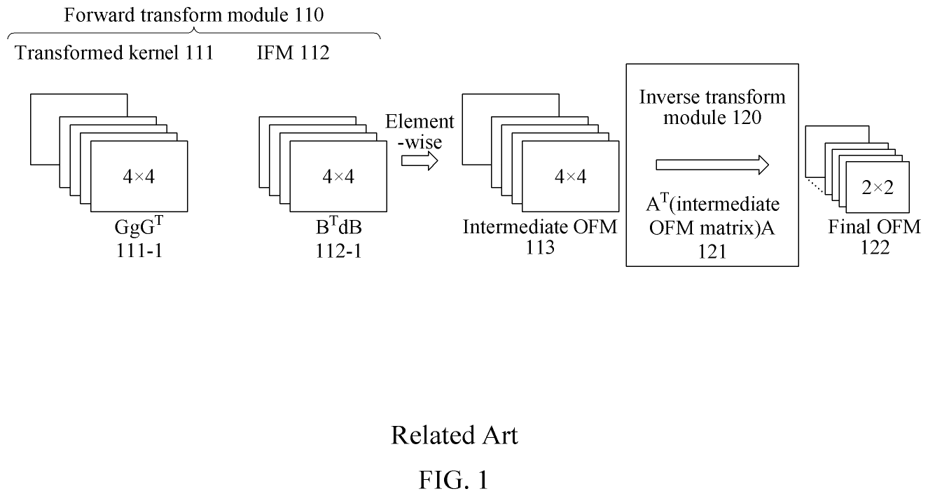

FIG. 1 illustrates an example two-dimensional (2D) WinConv method.

CNN typically receives input feature maps (IFMs), has kernels, and outputs output feature maps (OFMs). In 2D WinConv, an IFM is segmented into mini-blocks and each mini-block is transformed before multiplication with transformed kernels. At the end of the multiplications, a result of the multiplied matrix is converted to an OFM. Referring to FIG. 1, the IFM is converted to 4×4 matrices, which may also be referred to as mini-blocks in space and transformed domains. Each of the 4×4 mini-blocks (represented as “d”) is transformed into WinConv domain using a transformation matrix B and a transposed transformation matrix B^{T} to obtain a resultant 4×4 matrix B^{T}dB. Each of the 4×4 kernels (represented as “g”) is transformed into WinConv domain using transformation matrix G and a transposed transformation matrix GT to obtain a resultant 4×4 matrix GgG^{T}. In addition, an inverse transform operation may be performed following by an element-wise multiplication operation of resultant matrices (e.g., B^{T}dB and GgG^{T} in FIG. 1). As shown in FIG. 1, in the 2D WinConv, a forward transform module 110 converts IFMs and kernels into IFMs 112 and transformed kernels 111, which are 4×4 matrices (mini-blocks) in the space and transformed domains. In the IFMs 112, each of the mini-blocks “d” may be transformed into the WinConv domain using a transformation matrix B and a transposed transformation matrix B^{T} to obtain a 4×4 matrix B^{T}dB 112-1. In the transformed kernels 111, each 3×3 kernel “g” may be transformed into the WinConv domain using a transformation matrix G and a transposed transformation matrix GT to obtain the 4×4 matrix GgG^{T} 111-1. The matrices B and G specify linear combinations for inputs “d” and “g”, respectively. In addition, a 4×4 intermediate OFM matrix 113 is obtained by performing an element-wise multiplication operation on the resultant matrices B^{T}dB 112-1 and GgG^{T} 111-1. In addition, an inverse transform module 120 generates a final 2×2 OFM matrix 122 by performing a matrix multiplication operation of A^{T}(intermediate OFM matrix)A 121. For a depth-wise convolution, WinConv is also applied to each channel of an IFM.

A convolution may include multiplying a single function by a value inverted from another function and by integrating a multiplication result over an interval. In some examples herein, the convolution operation may refer to an operation of selecting a filter corresponding to a given purpose and extracting a specific feature from input data by scanning all of the regions of input data using the selected filter. For example, the system may acquire output data by performing a convolution operation of filter data with respect to input data and each piece of data may be defined in a matrix form. When data is defined in a form of a matrix, the convolution operation may include a matrix operation.

The matrix operation may include any possible arithmetic operations performed between a plurality of matrices. Non-limiting examples of such matrix operations include a matrix addition and subtraction, a scalar matrix multiplication, a matrix multiplication, and an element-wise matrix multiplication. Further, the matrix operation may include operations representable in the form of a matrix, for example, a linear equation.

The convolution operation may be characterized as a combination of a matrix addition and subtraction and a matrix multiplication. In such an example, an amount of time and power used for the matrix multiplication may be significantly greater than an amount of time and power used for the matrix addition and subtraction. From perspective of the system, reducing a number of matrix multiplication operations may be a way to improve a convolution operation processing speed and to reduce a power consumption occurring when performing such a convolution operation.

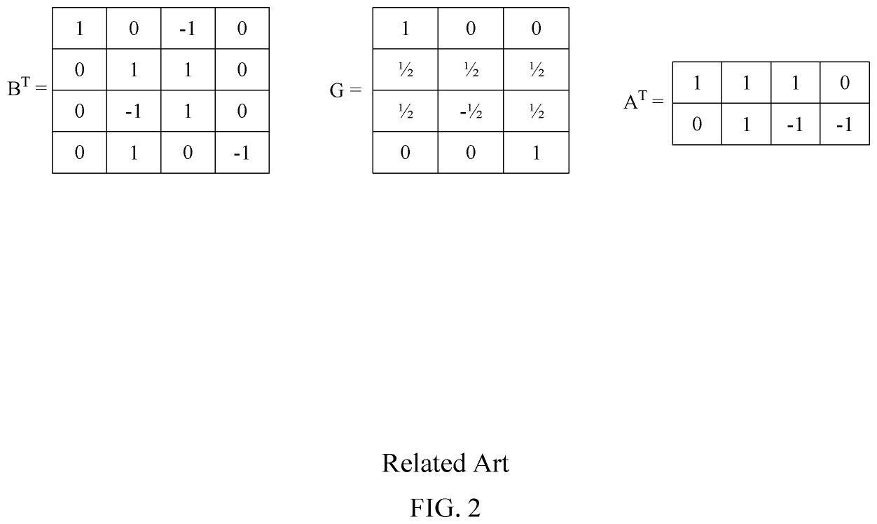

FIG. 2 illustrates an example of matrices used in a WinConv method.

Referring to FIG. 2, matrices B^{T}, G, and A^{T} are used in a WinConv method. The WinConv method includes forward and inverse transform operations for a 3×3 WinConv, for example. In addition, as shown in FIG. 2, WinConv uses a transposed transformation matrix B^{T} of the matrix B and a transposed transformation matrix A^{T}. A 2D WinConv is expressed in matrix form as shown in Equation 1 below.

Y=A^{T}[(GgG^{T})⊙(B^{T}dB)]A Equation 1

In Equation 1, Y denotes a 2×2 OFM and ⊙ denotes an element-wise multiplication.

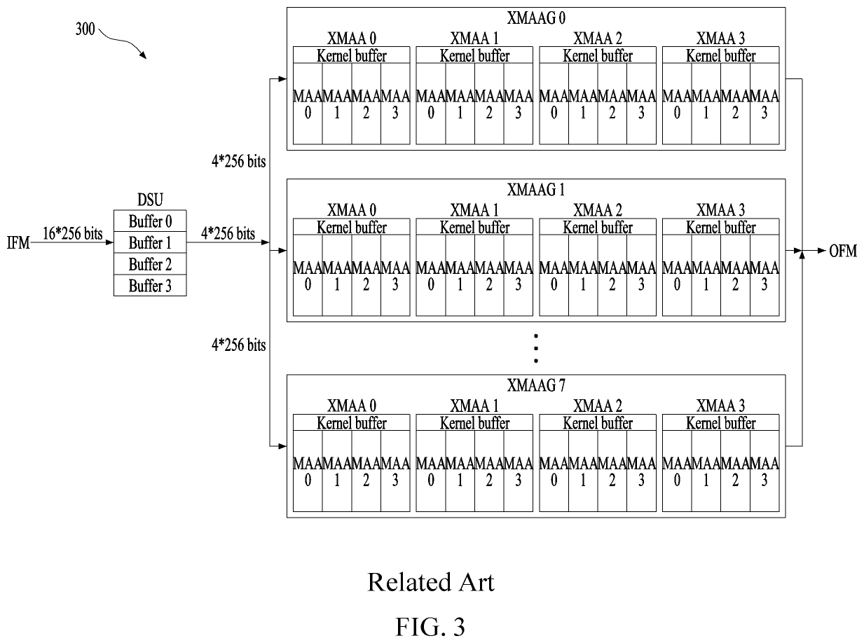

FIG. 3 illustrates an example baseline architecture for a three-dimensional (3D) WinConv.

Referring to FIG. 3, a baseline architecture 300 includes eight XMAAGs (e.g., XMAAG0 through XMAAG7).

Each of the XMAAGs includes four XMAAs (e.g., XMAA0, XMAA1, XMAA2, and XMAA3). The four XMAA0, XMAA1, XMAA2, and XMAA3 may be arranged as a group sharing a set of IFM vectors. In one group, each of the group members XMAAs (XMAA0, XMAA1, XMAA2, and XMAA3) includes multiply and accumulate array (MAAs) units (e.g., MAA0, MAA1, MAA2, and MAA3) arranged as one subgroup. In one subgroup, each of MAAs (e.g., MAA0, MAA1, MAA2, and MAA3) operates on different OFM pixels from an OFM channel.

In the baseline architecture 300, each XMAAG (XMAAG0 through XMAAG7) includes a group of four XMAAs (XMAA0, XMAA1, XMAA2, and XMAA3) sharing a set of IFM vectors, and each XMAA (any one of XMAA0, XMAA1, XMAA2, and XMAA3) includes a subgroup of MAAs (MAA0, MAA1, MAA2, and MAA3) sharing the same kernel.

In the 3D convolution, an IFM vector is shared among MAAs (e.g., MAA0, MAA1, MAA2, and MAA3) in all XMAAs (e.g., XMAA0, XMAA1, XMAA2, and XMAA3) included in each XMAAG of XMAAG0 through XMAAG7. Each XMAAG may receive IFM vectors that contribute to computation of four OFM pixels in an x-y plane from each of four OFM channels. In addition, as shown in FIG. 3, a data storage unit (DSU) having input buffers (e.g., buffers 0, 1, 2, and 3), each of which (the input buffers 0 through 4) stores IFM vectors in which data sparsity is exploited. An output (e.g., “4×256” bits of data) of the buffers may be broadcasted to each XMAAG of the baseline architecture 300. Thus, the eight XMAAGs compute “32” channels of OFM data with four pixels per channel, and accordingly a total of “4×32” OFM pixels are generated.

For a WinConv using the baseline architecture 300, forward and inverse transform modules (e.g., 110 and 120 in FIG. 1) are introduced at an input and an output of the baseline architecture 300. The forward and inverse transform modules 110 and 120 may include two layers of adders. The example baseline architecture 300 may require a computation logic for “16” input channels and “8” output channels, respectively. Therefore, two pixels of each of the transformed IFM (e.g., IFM 112) mini-blocks are fed to each XMAA, and pre-computed transformed kernels (e.g., the transformed kernels 111 in FIG. 1) corresponding to the two pixels may be populated in kernel buffers. In addition, outputs of all XMAAGs may be combined by the inverse transform module (e.g., 120 in FIG. 1) for an inverse transformation to generate “2×2×8” OFM pixels every cycle.

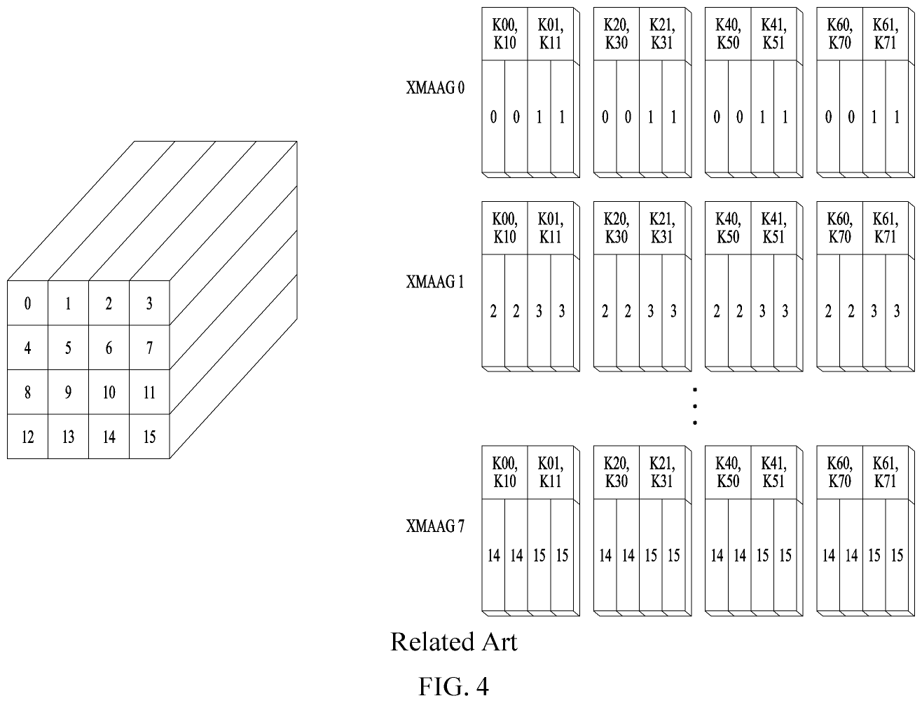

FIG. 4 illustrates an example 3D WinConv mapping of a baseline architecture.

Due to basic computations that involve addition of products in a z direction using adder trees in every computing element, mapping a depth-wise convolution on a z-first storage CNN accelerator architecture (e.g., the baseline architecture 300 of FIG. 3) designed for a 3D convolution may be difficult.

Some solutions have been designed to overcome at least one of the aforementioned problems regarding mapping of a depth-wise convolution on the z-first storage CNN accelerator architecture designed for the 3D convolution. For example, a general solution may be to use only a single multiplier per computing element, which is helpful in reducing resource utilization.

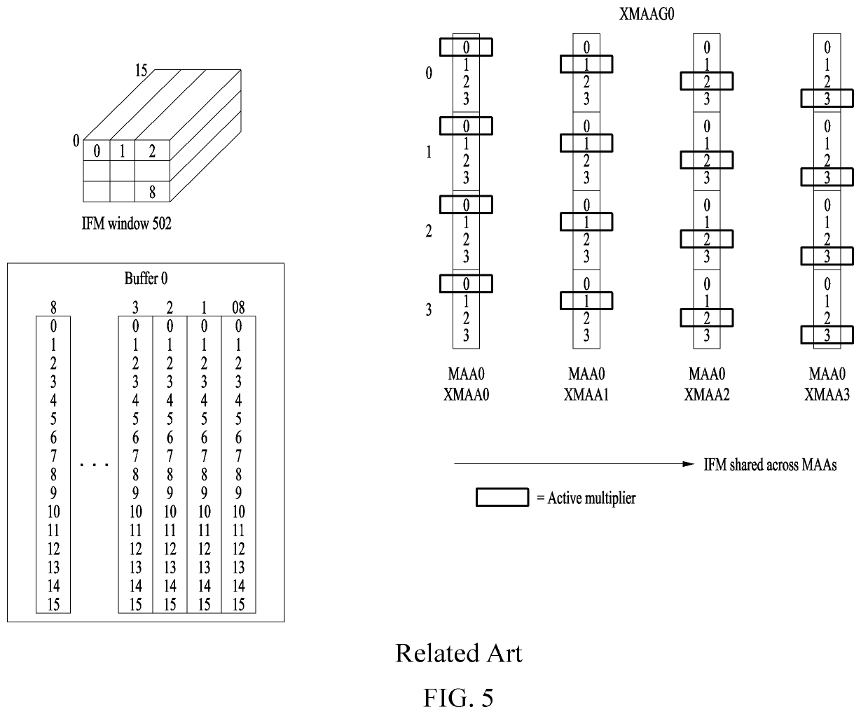

FIG. 5 schematically illustrates mapping a depth-wise convolution on a baseline architecture.

Referring to FIG. 5, channels 0 to 3 of first four pixels in an IFM window 502 may be concatenated with an input vector shared by MAA0s of an XMAAG0. Similarly, the remaining 12 channels (e.g., channels 4 to 15) may also input to MAA0s of XMAAG1 to XMAAG3. In addition, MAA1 to MAA3 of XMAAGs may receive pixels from adjacent IFMs and contribute to adjacent OFM pixels. According to this method, a mapping of a depth-wise convolution using the WinConv method in the baseline architecture 300 may be possible, similar to the 3D WinConv method. However, since the addition of the products in the z direction is not required in the depth-wise convolution, only one multiplier remains active in all MAAs, which may cause a problem in which the utilization of computing resources decrease, and the WinConv method may fail to show a higher performance.

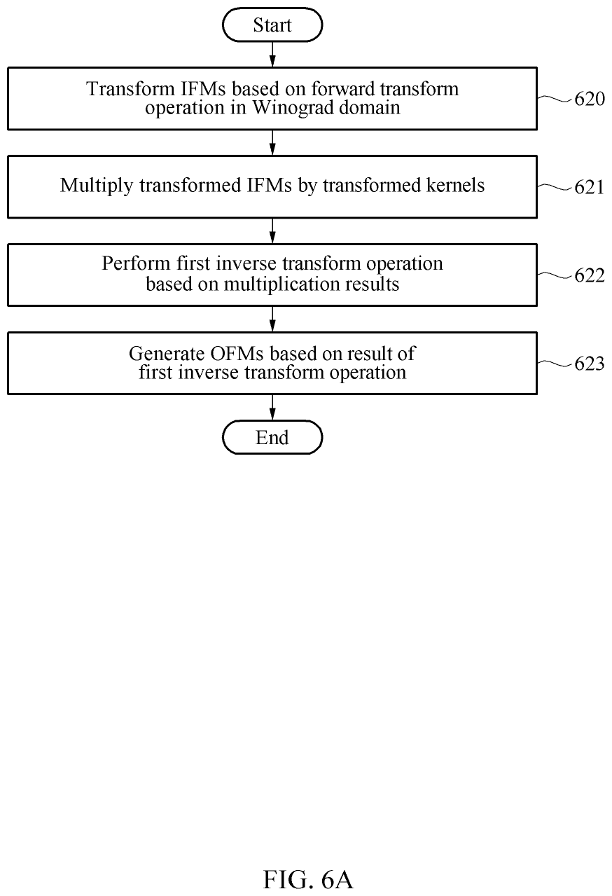

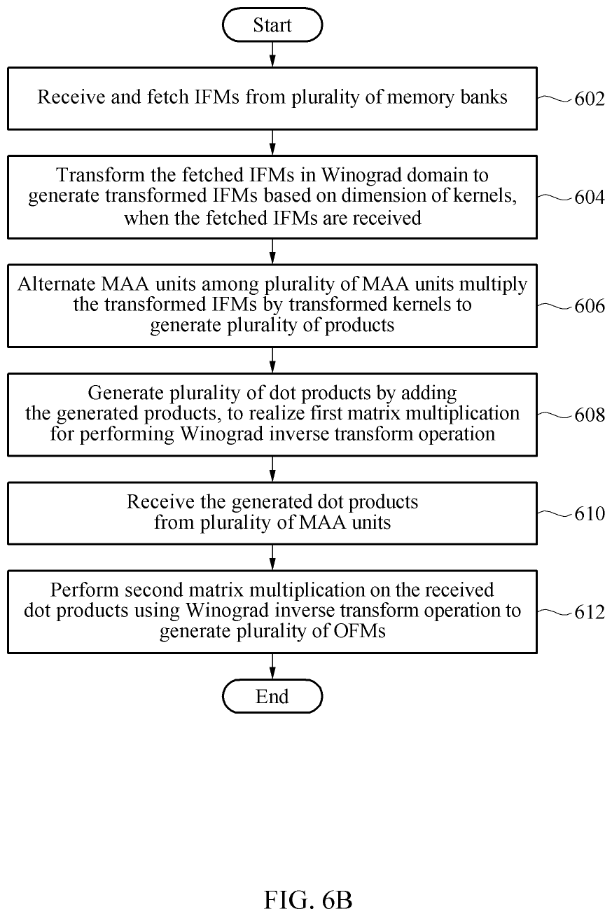

FIGS. 6A and 6B illustrate an example method of performing a WinConv operation according to one or more embodiments.

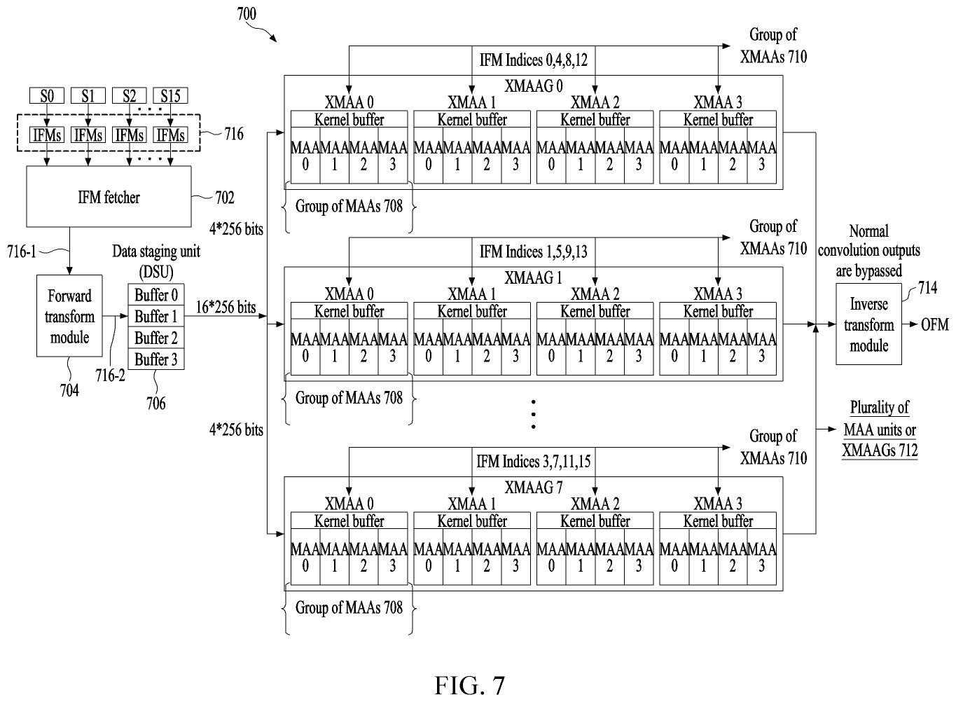

FIG. 7 illustrates an example system for performing a WinConv operation according to one or more embodiments.

The description provided with reference to FIGS. 1 to 5 may apply to the examples of FIGS. 6A, 6B, and 7.

In one or more embodiments, operations illustrated in FIGS. 6A and 6B may be performed in the shown order and manner. However, the order of some operations may change, or some of the operations may be omitted, without departing from the spirit and scope of the shown embodiment. The operations illustrated in FIGS. 6A and 6B may be performed in parallel, simultaneously, or any other sequence/order that is suitable to the method of performing the WinConv operation.

In FIG. 7, one or more blocks and a combination thereof may be implemented by a special-purpose hardware-based computer that performs a predetermined function, or a combination of computer instructions and special-purpose hardware.

Referring to FIGS. 6A, 6B, and 7, a system 700 may perform an energy-efficient depth-wise WinConv operation on a z-first storage CNN accelerator. Functions of components of the system 700 are described with reference to FIGS. 6A through 10.

The system 700 may include an IFM fetcher 702, a forward transform module 704 (e.g., the forward transform module 110 of FIG. 1), a data staging unit (DSU) 706, a plurality of MAA units or XMAAGs 712 (hereinafter, referred to as “XMAAGs 712”), and an inverse transform module 714.

In one example, as shown in FIG. 7, the system 700 may include eight XMAAGs 712 (XMAAG0 through XMAAG7), but is not limited to such a configuration. Alternatively, the system 700 may include fewer than or more than eight XMAAGs 712 as long as the number of the XMAAGs is suitable to optimize the performance of the system 700.

Each of the XMAAGs 712 may include a group of XMAAs 710 (e.g., XMAA0, XMAA1, XMAA2, and XMAA3). Each of XMAAs 710 (e.g., XMAA0, XMAA1, XMAA2, and XMAA3) may include a group of MAAs 708 (e.g., MAA0, MAA1, MAA2, and MAA3). Each group of MAAs 708 may share the same kernel, and each group of XMAAs 710 may share a set of IFM vectors.

In one example, a group of XMAAs 710 may include 4 XMAA elements (XMAA0, XMAA1, XMAA2, and XMAA3), and each XMAA element may include 4 MAA elements arranged as a group of MAAs 708. One group of MAAs 708 may be referred to as a subgroup within one group of XMAAs 710, and there may be 4 subgroups of MAAs 708 within one group of XMAAs 710. Alternatively, the system 700 may include fewer than or more than 4 subgroups of MAAs 708 as long as the number of the subgroups is suitable to optimize the performance of the system 700.

The system 700 may include a plurality of memory banks S0 through S15 coupled to the IFM fetcher 702 to store and provide IFMs 716. In one example, the number of the memory banks is not limited to 16 as shown in FIG. 7, but may be fewer than or more than 16 as long as the number of the memory banks is suitable to optimize the performance of the system 700. The aforementioned components of the system 700 may be coupled to each other for a transmission of computational data from one component to another component in the system 700.

In one example, the XMAAGs 712 may include a plurality of adder trees and a plurality of multipliers. Within each of XMAAGs 712, the adder trees and multipliers are configured to correspond to each group of MAAs 708 within a group of XMAAs 710.

In one example, the XMAAGs 712 may include two sets of MAA units, for example, a set of MAA0 and MAA2, and a set of MAA1 and MAA3, in each XMAA within a group of XMAAs 710. In the present disclosure, the set of the MAA0 and MAA2 may also be referred to as a first set of MAA units, and the set of the MAA1 and MAA3 may also be referred to as a second set of MAA units without departing from the scope of the present disclosure. Also, multipliers of the MAA0 and MAA2 may also be referred to as a first set of multipliers, and multipliers of the MAA1 and MAA3 may also be referred to as a second set of multipliers without departing from the scope of the present disclosure.

The first set of MAA units may correspond to alternate MAA units MAA0 and MAA2 in a group of MAAs 708 within each of the XMAAs 710 of the respective XMAAGs 712. The first set of MAA units may include the first set of multipliers. The second set of MAA units may correspond to alternate MAA units MAA1 and MAA3 in a group of MAAs 708 within each of the XMAAs 710 of the respective XMAAGs 712. The second set of MAA units may include a second set of multipliers.

The system 700 may also be referred to as an architecture of a z-first NPU. The system 700 may also be referred to as a z-first storage CNN accelerator for performing an energy-efficient depth-wise WinConv operation. In one example, a baseline architecture with half-precision floating-point (FP16) arithmetic support may perform an energy-efficient depth-wise WinConv operation on a z-first storage CNN accelerator. The baseline architecture is not limited to the architecture described above. Moreover, it will be understood by one of ordinary skill in the art aspects of the architectures described herein are applicable to any type of system configured to perform a depth-wise WinConv operation on a z-first storage CNN accelerator. The aforementioned example of FP16 is merely a non-limiting example, and thus, the system 700 may also support different data types, and is not limited to integer data types, floating-point data types, and the like.

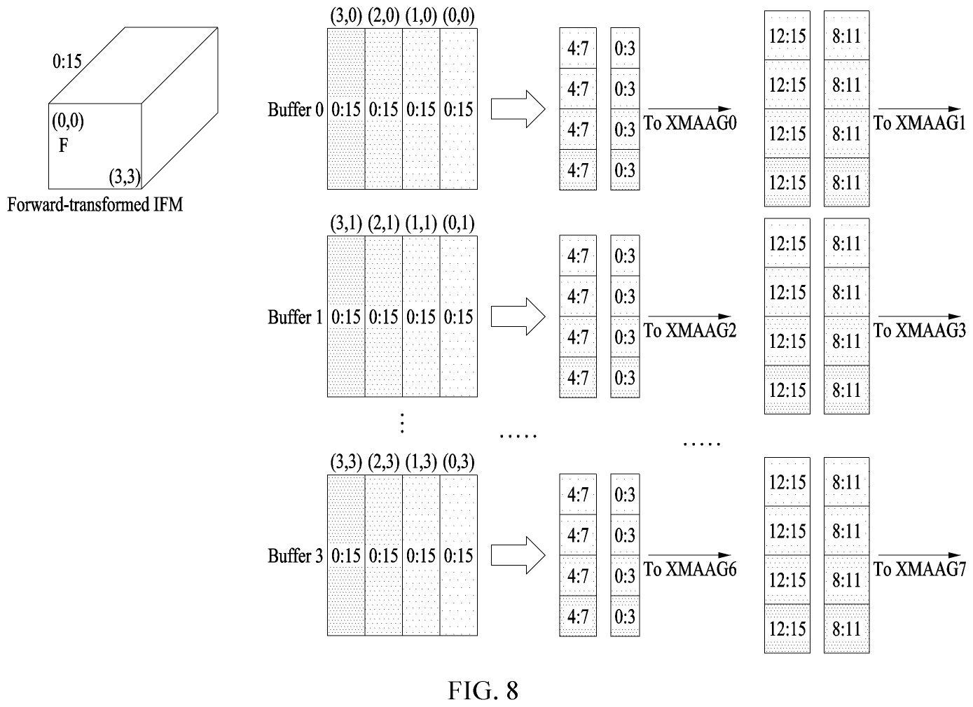

Operations 602 through 612 in FIG. 6B and operations 620 through 623 in FIG. 6A are described as being performed using the system 700 of FIG. 7. However, these operations may be performed by any suitable electronic device and in any suitable system. Moreover, these operations will be described in detail together with a description of FIGS. 8 through 10. The system 700 may include a processor-implemented or computer-implemented apparatus for accelerating an artificial neural network.

FIG. 6A illustrates operations 620 through 623 of an artificial neural network acceleration method performed by the system 700 according to one or more embodiments.

In operation 620, the system 700 may transform IFMs based on a forward transform operation in a WinConv domain.

In operation 621, the system 700 may multiply the transformed IFMs by transformed kernels.

In operation 622, the system 700 may perform a first inverse transform operation based on multiplication results obtained by multiplying the transformed IFMs by transformed kernels. In one example, the system 700 may perform the first inverse transform operation based on the multiplication results and a transposed output transformation matrix (e.g., A^{T} in FIG. 2).

In operation 623, the system 700 may generate OFMs based on a result of the first inverse transform operation. In one example, the system 700 may generate OFMs by performing a second inverse transform operation on the result of the first inverse transform operation and the output transformation matrix (e.g., a matrix A in Equation 1).

Operations 620 through 623 will be further described through operations 602 through 612 which are described with reference to FIG. 6B.

In operation 602, an IFM fetcher 702 may receive and fetch IFMs 716 from a plurality of memory banks. In one example, the IFM fetcher 702 may fetch IFMs 716 that are received from the plurality of memory banks S0 through S15. In a depth-wise WinConv mode, the plurality of memory banks S0 through S15 may be configured to store channels of coordinates of each of the IFMs 716 in a z-first data storage layout as IFM blocks. Each of the IFM blocks may have a size of 4×4.

In one example, the plurality of memory banks S0 through S15 may be configured to provide the IFMs 716 to the IFM fetcher 702 in parallel, simultaneously, or any other sequence/order that is suitable to optimize the performance of the system 700. The IFM fetcher 702 may fetch the received IFMs 716 from the memory banks S0 through S15 and transmit fetched IFMs 716-1 to the forward transform module 704 in the depth-wise WinConv mode.

When the fetched IFMs 716-1 are received, in operation 604, the forward transform module 704 (in the depth-wise WinConv mode) may transform the fetched IFMs 716-1 in the WinConv domain to generate transformed IFMs 716-2; the transform may be based on a dimension of kernels.

To transform the fetched IFMs 716-1 into the WinConv domain, the forward transform module 704 may select a transformation matrix and a transposed transformation matrix based on a size of a corresponding kernel and a position of a corresponding IFM window. Subsequently, the forward transform module 704 may transform the fetched IFM 716-1 into the WinConv domain based on the size of the kernel, the selected transformation matrix, and the selected transposed transformation matrix, to generate the transformed IFMs 716-2. For example, a plurality of kernels may have a size of “3×3”, and a plurality of transformed IFMs 716-2 may have a size of “4×4”.

In one example, a kernel size of “3×3”, “3×1”, or “1×3” may be used to generate a transformed IFM. In one example, the forward transform module 704 may use a kernel with the size of “3×3” to generate a transformed IFM with a size of “4×4”. The forward transform module 704 may use a kernel with the size of “3×1” to generate a transformed IFM with a size of “4×1”. The forward transform module 704 may use a kernel with the size of “1×3” to generate a transformed IFM with a size of “1×4”. The forward transform module 704 may select a transformation matrix and a transposed transformation matrix based on the size of the kernel and subsequently transform an IFM into the WinConv domain based on the selected transformation matrix, the selected transposed transformation matrix, and a position of an IFM window. Examples are not limited to the kernel sizes described above, and a kernel size of “5×5” may also be used to transform an IFM. It will be understood by one of ordinary skill in the art that the above-described examples are merely illustrative and are not intended to limit the scope of the present disclosure.

Similarly, one of the kernel sizes of “3×3”, “3×1”, and “1×3” may be used to generate a transformed kernel (e.g., the transformed kernel 111 of FIG. 1). In another example, the forward transform module 704 may use a kernel with the size of “3×3” to generate a transformed kernel with a size of “4×4”. The forward transform module 704 may use a kernel with the size of “3×1” to generate a transformed kernel with a size of “4×1”, and may use a kernel with the size of “1×3” to generate a transformed kernel with a size of “1×4”.

The forward transform module 704 may transmit the transformed IFMs 716-2 to the data staging unit (DSU) 706. The DSU 706 may distribute the transformed IFMs 716-2 to a plurality of IFM buffers (e.g., buffers 0, 1, 2, and 3). The number of the IFM buffers is not limited to 4 as shown in FIG. 7, and may be fewer than or more than 4 as long as the number of the IFM buffers is suitable to optimize the performance of the system 700.

In one example, the DSU 706 may rearrange the transformed IFMs 716-2 such that four pixels from each channel may be provided together at an input terminal of each of alternate MAA units MAA0 and MAA2 of the plurality of MAA units 712. In one example, the transformed IFMs 716-2 may be rearranged by the DSU 706 so that four pixels from each channel are provided together at the input terminal of each of alternate MAA units among groups of MAAs 708 within each of the XMAAs 710 of the respective XMAAGs 712. An example of distributing the transformed IFMs 716-2 to the plurality of IFM buffers (e.g., buffers 0, 1, 2, and 3) is described with reference to FIG. 8.

FIG. 8 illustrates an example distribution of forward-transformed IFMs into data buffers according to one or more embodiments.

The description provided with reference to FIGS. 1 through 7 may apply to the example of FIG. 8.

Referring to FIGS. 6B, 7 and 8, in operation 604, the system 700 may generate data indices that are read from the plurality of memory banks S0 through S15 into data buffers 0 through 3 of the DSU 706 via the forward transform module 704. The DSU 706 may read the transformed IFMs 716-2 from the forward transform module 704 and then distribute the transformed IFMs 716-2 to the IFM buffers according to indices of the IFM buffers. Accordingly, the DSU 706 may distribute input data among all available XMAAs 710 of the respective XMAAGs 712.

When the transformed IFMs 716-2 are generated, the alternate MAA units among the plurality of MAA units 712 may multiply the transformed IFMs 716-2 by the transformed kernels (e.g., the transformed kernels 111 in FIG. 1) to generate a plurality of products in operation 606. In one example, the plurality of MAA units 712 may multiply the transformed IFMs 716-2 by the transformed kernels in the alternate MAA units MAA0 and MAA2 (in the group of MAAs 708 within each of the XMAAs 710 of the respective XMAAGs 712), to generate the plurality of products. A transformed kernel with the size of “4×4” may be used for a multiplication operation.

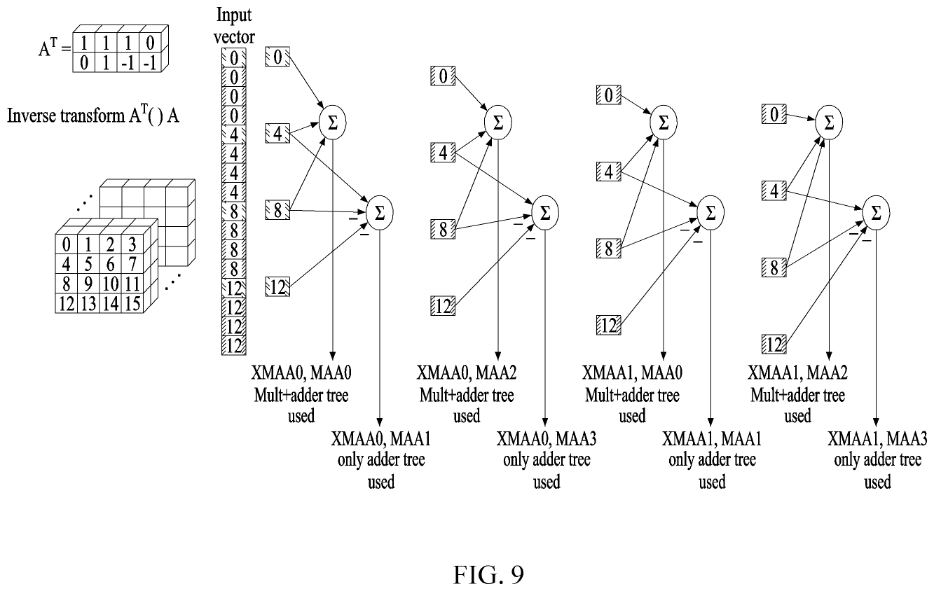

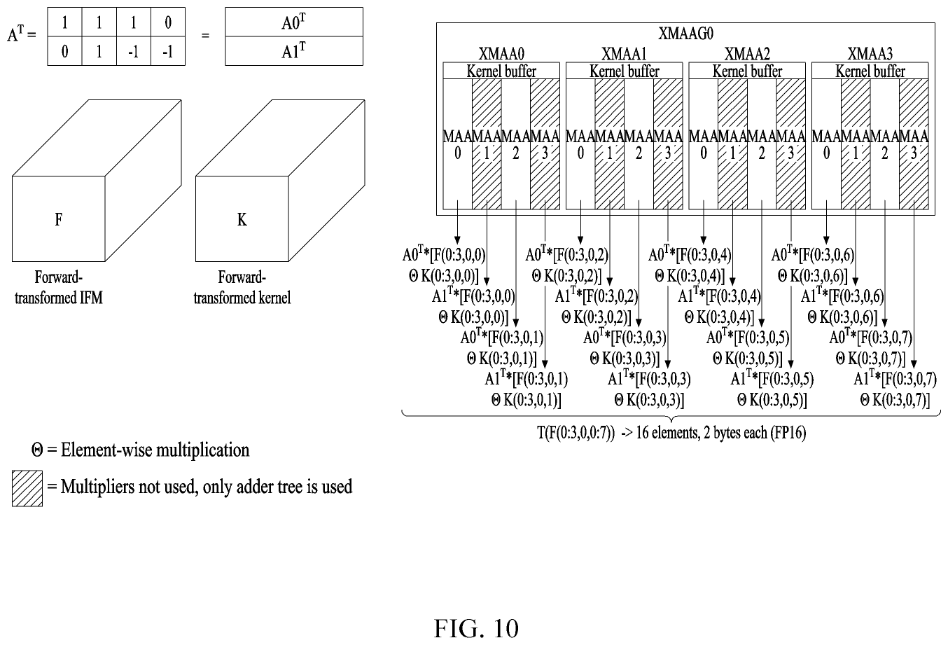

When the transformed IFMs 716-2 and the transformed kernels 111 are multiplied in the alternate MAA units, the plurality of MAA units 712 of the system 700 may generate a plurality of dot products by adding the plurality of generated products, to realize a first matrix multiplication for a WinConv inverse transform operation in operation 608. The first matrix multiplication may correspond to the first inverse transform operation described above. The plurality of generated dot products may correspond to output results of an element-wise multiplication operation based on the adding of the plurality of generated products. The plurality of dot products may correspond to results of the first inverse transform operation described above. In one example, the plurality of adder trees of the plurality of MAA units 712 may add the plurality of generated products, to generate the plurality of dot products. An example of the multiplying and adding described above is described in with reference to FIGS. 9 and 10.

FIG. 9 illustrates an example computation performed by XMAAs in a depth-wise WinConv mode according to one or more embodiments.

FIG. 10 illustrates an example computation performed by XMAAGs in a depth-wise WinConv mode according to one or more embodiments.

Referring to FIG. 9, the system 700 may multiply a transformed IFM 716-2 by a transformed kernel (e.g., the transformed kernel 111 of FIG. 1) in an alternate MAA unit using a multiplier, and may add the plurality of generated products using an adder tree.

In one example, the first inverse transform operation may be performed in the plurality of MAA units 712. Since an inverse transformation matrix (e.g., A^{T} in FIG. 2) includes an addition and a subtraction, addition and subtraction operations may be performed using adders in adder trees of the plurality of MAA units 712. Since two rows of the inverse transform matrix involve different additions and subtractions, the generated products in the alternate MAA units among the plurality of MAA units 712 may be shared to adder trees of the MAA0 and MAA1 and adder trees of the MAA2 and MAA3, respectively using bypass paths between two MAAs. The term “bypass” used herein indicates that the products from the multipliers are not used in adder trees of MAA1 and MAA3. However, products from MAA units, i.e., MAA0 and MAA2 among the plurality of MAA units 712 may be used for only a generation of the plurality of dot products.

Accordingly, for multiplication of the transformed IFMs 716-2 by the transformed kernels 111 in the first set of MAA units (e.g., alternate MAA units MAA0 and MAA2 in the group of MAAs 708 within each of the XMAAs 710 of the respective XMAAGs 712), the second set of MAA units may disable the second set of multipliers based on a zero gating at input terminals of the second set of multipliers when multiplying the transformed IFMs 716-2 by the transformed kernels 111 in the first set of MAA units is performed. Moreover, the second set of MAA units may maintain the second set of multipliers to be in a state of being disabled when the addition of the plurality of generated products is performed.

In one example, as shown in FIG. 9, input vectors corresponding to four pixels from each channel may be provided together at an input terminal of MAAs in the XMAA0 and XMAA1 of the XMAAs 710. Moreover, considering a first row of the transposed matrix A^{T} (also in FIG. 2) and a first column of a transformed IFM, a multiplier and an adder tree of the MAA0 in each XMAA0 may be used for the multiplication operation and the addition operation as described above.

In another example, for a second row of the transposed matrix A^{T} and the first column of the transformed IFM, only an adder tree of the MAA1 in each XMAA0 may be used to perform the addition operation. A similar process may be repeated for each of the plurality of MAA units 712 in each of the XMAAs 710 of the respective XMAAGs 712.

In the embodiment illustrated by FIG. 9, for the MAA0 and MAA2 of each of the XMAA0 and XMAA1, both multipliers and adder trees may be used for multiplication and addition. However, MAA1 and MAA3 of each of the XMAA0 and XMAA1 may use adder trees only when multiplication and addition are performed, and multipliers of the MAA1 and MAA3 of each of the XMAA0 and XMAA1 may be disabled. Therefore, the multipliers of the MAA1 and MAA3 may not participate in the multiplication operation and adders in the adder trees of the MAA1 and MAA3 may remain active to receive inputs from the MAA0 and MAA2 via bypass paths between the MAAs.

It will be understood by one of ordinary skill in the art that the above-described examples are merely illustrative and are not intended to limit the scope of the present disclosure. In addition, when the depth-wise WinConv operation is performed on the z-first storage CNN accelerator, the second set of multipliers may remain disabled.

In one embodiment as shown in FIG. 10, both the first set of multipliers and the adder trees of the alternate MAA units MAA0 and MAA2 in the group of MAAs 708 within the XMAAs 710 of the XMAAG0 may be used for an element-wise multiplication of forward-transformed IFMs 716-2 denoted by “F” and forward-transformed kernels denoted by “K”. Only the adder trees of the second set of MAA units MAA1 and MAA3 in the group of MAAs 708 within the XMAAs 710 of the XMAAG0 may be used for the element-wise multiplication of the forward-transformed IFM 716-2 (F) and the forward-transformed kernel (K), and the multipliers of the second set of MAA units may be disabled when the element-wise multiplication is performed.

In the above-described example, the plurality of products generated by the MAA units within the XMAAGs 712 as a result of the multiplication operation may be shared using bypass paths between two MAAs. Thus, the plurality of dot products (e.g., results of the first inverse transform operation) may be generated by the plurality of adder trees to realize the first inverse transform operation (e.g., a first matrix multiplication for a WinConv inverse transform operation). Moreover, the plurality of MAA units within the XMAAGs 712 may transfer the plurality of generated dot products to the inverse transform module 714, and the second inverse transform operation (e.g., a second matrix multiplication in an inverse transform operation) may be performed in the inverse transform module 714.

In one example, a first number of multipliers among the first set of multipliers may be used by the first set of MAA units to multiply the transformed IFMs 716-2 F by the transformed kernels K. Moreover, the rest of the multipliers (i.e., a second number of multipliers among the first set of multipliers other than the first number of multipliers) may be disabled during a multiplication operation based on zero gating at input terminals of the second number of multipliers.

In operation 610, the inverse transform module 714 of the system 700 may receive the plurality of generated dot products (e.g., the results of the first inverse transform operation) from the plurality of MAA units or XMAAGs 712.

When the plurality of dot products (e.g., the results of the first inverse transform operation) is received using the inverse transform module 714, the system 700 may perform a second matrix multiplication (e.g., a second inverse transform operation) on the plurality of received dot products using a WinConv inverse transform operation, to generate a plurality of OFMs in operation 612. In one example, the inverse transform module 714 of the system 700 may perform the second matrix multiplication on the plurality of received dot products for a second stage of multiplication (i.e., the second matrix multiplication) in the WinConv inverse transform operation, and may generate the plurality of OFMs based on second matrix multiplication of the plurality of received dot products. The second matrix multiplication may be a second inverse transform operation using an output transformation matrix, and a matrix used for the second matrix multiplication may be the matrix A in Equation 1.

In the above-described examples and embodiments, a portion of the inverse transform operation may be performed on the XMAAs 710 of the XMAAGs 712. In one example, the first inverse transform operation may be performed on the plurality of MAA units of the XMAAGs 712 using the adder trees of the MAA units of the XMAAGs 712, whereas the second inverse transform operation may be performed on the inverse transform module 714. Therefore, in the aforementioned type of the depth-wise WinConv mapping method, a plurality of multipliers and adder trees may be efficiently used in XMAAGs. Thus, it may be possible to increase resource utilization and improve the overall performance of the system 700.

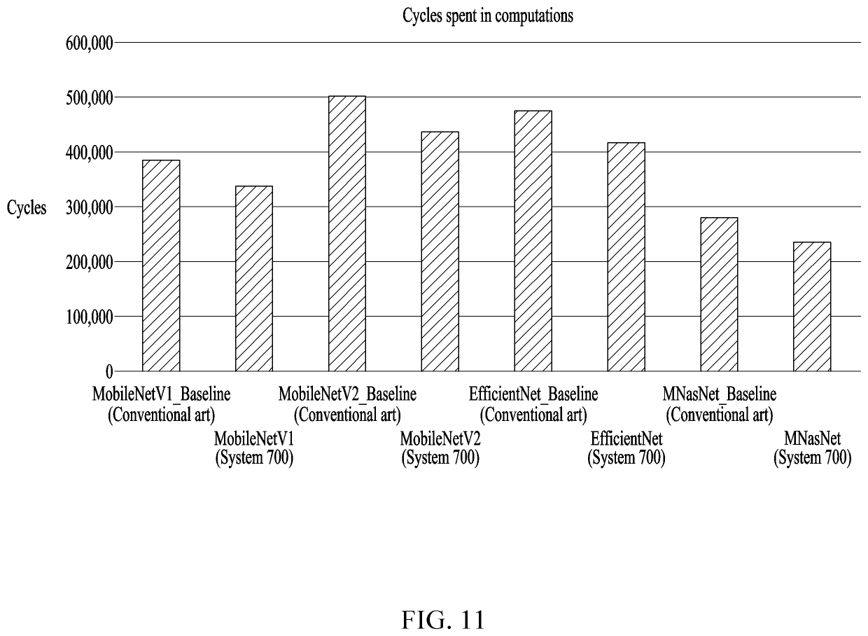

FIG. 11 illustrates an example comparison of results of a depth-wise convolution operation according to one or more embodiments.

In a depth-wise WinConv method according to one embodiment, a 3× improvement effect in 3×3 depth-wise convolution layers may be obtained. On average, a speed may increase by more than 13.8% on average in a depth-wise-based CNN. FIG. 11 illustrates an example of a comparison of cycles spent in computations between the system 700 with the depth-wise WinConv operation and other CNNs. These other CNNs may include, but are not limited to, MobileNetV1, MobileNetV2, EfficientNet, and MNasNet.

In a depth-wise computation mapping in the conventional art, an inactive row may be included in an MAA. Since the inactive row contributes to power consumption, an input may be forced to a zero to avoid switching of a logic on a path. However, XMAAGs of the system 700 are configured to consume only two data vectors, whereas four data vectors are consumed in a conventional method.

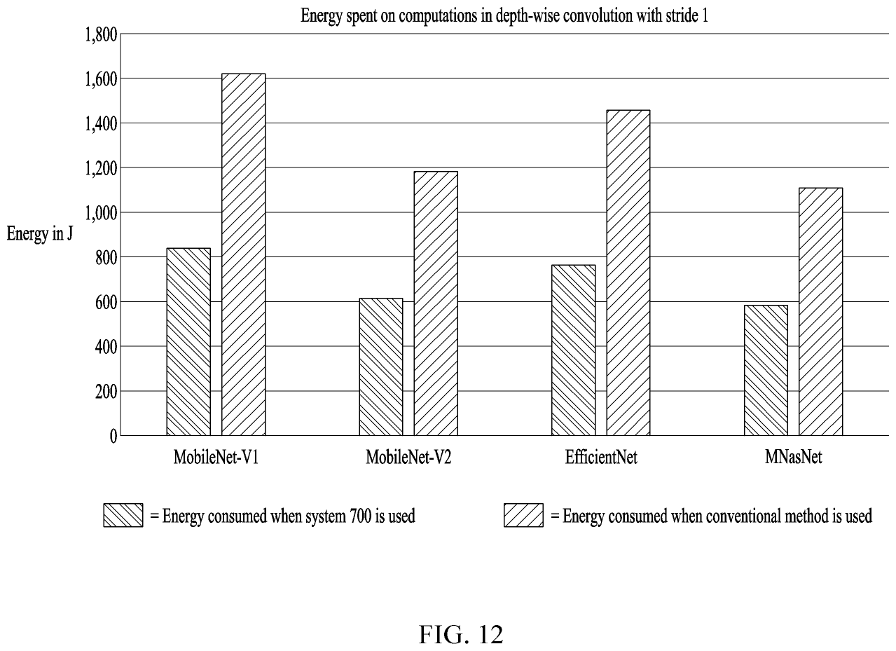

FIG. 12 illustrates an example comparison of energy spent in a depth-wise convolution according to one or more embodiments.

The method and system according to one embodiment may consume relatively low energy in comparison to the conventional method due to an increase in a speed of a computation cycle. FIG. 12 illustrates an example of a comparison of energy spent on in a depth-wise convolution with stride 1 between the system 700 with the depth-wise WinConv operation and other CNNs such as MobileNetV1, MobileNetV2, EfficientNet, MNasNet. Referring to the graph shown in FIG. 12, energy consumed in 3×3 depth-wise convolution layers may be 1.9-fold reduced by the system 700 using a depth-wise WinConv mapping according to the above non-limiting examples.

The forward transform module 110, the transformed kernel 111, the IFM 112, the intermediate OFM 113, the inverse transform module 120, the A^{T}(intermediate OFM matrix)A 121, the OFM 122, the system 700, the IFM fetcher 702, the forward transform module 704, the data staging unit (DSU) 706, the units 710 and 712, the inverse transform module 714, and the IFM 716 described herein and disclosed herein described with respect to FIGS. 1-12 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An processor-implemented apparatus comprising:
a forward transform module to transform input feature maps (IFMs) by performing a forward transform operation in a Winograd convolution (WinConv) domain;
multiply and accumulate array (MAA) units to multiply the transformed IFMs by transformed kernels and perform a first inverse transform operation based on results of the multiplying, the MAA units comprising adder trees and multipliers; and
an inverse transform module to generate output feature maps (OFMs) based on a result of the first inverse transform operation.

2. The apparatus of claim 1, wherein
the MAA units are configured to perform the first inverse transform operation based on the results of the multiplying and an output transformation matrix that is transposed, and
the inverse transform module is configured to generate the OFMs by performing a second inverse transform operation on the result of the first inverse transform operation and the output transformation matrix.

3. The apparatus of claim 1, wherein
the MAA units comprise a first set of MAA units and a second set of MAA units, and
the first set of MAA units corresponds to first alternate MAA units, and the second set of MAA units corresponds to second alternate MAA units.

4. The apparatus of claim 3, wherein
the first set of MAA units comprises a first set of multipliers among the multipliers,
the second set of MAA units comprises a second set of multipliers, other than the first set of multipliers, among the multipliers, and
the second set of MAA units is configured to disable the second set of multipliers based on a zero gating at input terminals of the second set of multipliers, during the multiplying of the transformed IFMs and the transformed kernels in the first set of MAA units.

5. The apparatus of claim 3, wherein
a first number of multipliers in the first set of multipliers is used by the first set of MAA units for the multiplying of the transformed IFMs and the transformed kernels, and
a second number of multipliers, other than the first number of multipliers, in the first set of multipliers, are disabled during the multiplying of the transformed IFMs and the transformed kernels based on a zero gating at input terminals of the second number of multipliers.

6. The apparatus of claim 1, wherein the plurality of MAA units is configured to:
perform the first inverse transform operation based on the results of the multiplying, using an addition operation in the adder trees; and
generate a plurality of dot products as the result of the first inverse transform operation.

7. The apparatus of claim 1, wherein the inverse transform module is configured to:
perform a second inverse transform operation on the result of the first inverse transform operation, using a WinConv inverse transform operation; and
generate the OFMs based on a result of the second inverse transform operation.

8. The apparatus of claim 1, wherein the transformed kernels are transformed into the WinConv domain by the MAA units.

9. The apparatus of claim 1, further comprising:
a plurality of memory banks configured to store channels of coordinates of each of the IFMs as IFM blocks in a z-first data storage layout and transmit the IFM blocks to an IFM fetcher; and
the IFM fetcher configured to fetch the IFM blocks.

10. The apparatus of claim 1, further comprising:
a data staging unit configured to distribute the transformed IFMs into a plurality of IFM buffers and rearrange the transformed IFMs so that at least four pixels per channel are provided together at an input terminal of each of the plurality of MAA units.

11. The apparatus of claim 1, wherein the forward transform module is configured to:
select a transformation matrix and a transposed transformation matrix based on a size of a kernel and a position of an IFM window; and
transform the IFMs into the WinConv domain based on the size of the kernel, the selected transformation matrix, and the selected transposed transformation matrix, to generate the transformed IFMs.

12. A processor-implemented method, comprising:
transforming input feature maps (IFMs) based on a forward transform operation in a WinConv domain;
multiplying, by multiply and accumulate array (MAA) units, the transformed IFMs by transformed kernels, the MAA units comprising adder trees and multipliers;
performing a first inverse transform operation based on results of the multiplying; and
generating output feature maps (OFMs) based on a result of the first inverse transform operation.

13. The method of claim 12, wherein
the performing of the first inverse transform operation comprises performing the first inverse transform operation based on the results of the multiplying and an output transformation matrix that is transposed, and
the generating of the OFMs comprises generating the OFMs by performing a second inverse transform operation on the result of the first inverse transform operation and the output transformation matrix.

14. The method of claim 12, wherein
the MAA units comprises a first set of MAA units and a second set of MAA units, and
the first set of MAA units corresponds to alternate MAA units, and the second set of MAA units corresponds to second alternate MAA units.

15. The method of claim 14, wherein
the first set of MAA units comprises a first set of multipliers among the multipliers,
the second set of MAA units comprises a second set of multipliers other than the first set of multipliers among the multipliers, and
the second set of MAA units is configured to disable the second set of multipliers based on a zero gating at input terminals of the second set of multipliers, during the multiplying of the transformed IFMs and the transformed kernels in the first set of MAA units.

16. The method of claim 14, wherein
a first number of multipliers in the first set of multipliers is used by the first set of MAA units for the multiplying of the transformed IFMs and the transformed kernels, and
a second number of multipliers other than the first number of multipliers in the first set of multipliers is disabled during the multiplying of the transformed IFMs and the transformed kernels based on a zero gating at input terminals of the second number of multipliers.

17. The method of claim 12, wherein the MAA units is configured to:
perform the first inverse transform operation based on the results of the multiplying, using an addition operation in the adder trees; and
generate a plurality of dot products as the result of the first inverse transform operation.

18. The method of claim 12, wherein the generating of the OFMs comprises:
performing a second inverse transform operation on the result of the first inverse transform operation, using a WinConv inverse transform operation; and
generating the OFMs based on a result of the second inverse transform operation.

19. The method of claim 12, wherein the transformed kernels are transformed into the WinConv domain by the MAA units.

20. The method of claim 12, further comprising:
storing channels of coordinates of each of the IFMs as IFM blocks in a z-first data storage layout; and
fetching the IFM blocks.
